(19) United States
(12) Patent Application Publication
(10) Pub. No.: US 2009/0185109 A1
(43) Pub. Date: Jul. 23, 2009

(54) LIQUID CRYSTAL DISPLAY

(75) Inventors: Byung-Seo Yoon, Incheon (KR); Heu-Gon Kim, Yongin-si (KR); Taek-Sun Shin, Cheonan-si (KR); In-Sun Hwang, Suwon-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/352,124

(22) Filed: Jan. 12, 2009

(30) Foreign Application Priority Data
Jan. 16, 2008 (KR) 10-2008-0005068

(51) Int. Cl. G02F 1/13357

(52) U.S. Cl. 349/65

(57) ABSTRACT

A liquid crystal display capable of improving display quality while achieving a reduction in manufacturing cost. The liquid crystal display includes a liquid crystal panel having multiple pixels arranged at a first pitch; a light source for supplying light to the liquid crystal panel; and a light guide plate for guiding the light to the liquid crystal panel, wherein prisms are formed on the light guide plate at a second pitch, the second pitch is the sum of a quotient and a corrected value, the quotient is obtained by dividing the first pitch by a natural number m, the corrected value depends on a selected viewing distance and an interval between the liquid crystal panel and the prisms.

This application claims priority to Korean Patent Application No. 10-2008-0005068, filed on Jan. 16, 2008, and all the benefits accruing therefrom under 35 U.S.C. §119, the contents of which in its entirety are herein incorporated by reference.

### BACKGROUND OF THE INVENTION

1. Field of the Invention

This disclosure relates to a liquid crystal display, and, more particularly, a liquid crystal display capable of improving display quality while achieving a reduction in the manufacturing cost.

2. Description of the Related Art

Liquid crystal displays generally include a liquid crystal panel and a backlight unit. The liquid crystal panel can include two substrates having a plurality of field-generating electrodes, including pixel electrodes and a common electrode, arranged thereon, and a layer of a liquid crystal material, the liquid crystal material including a liquid crystal molecule interposed between the two substrates. In a liquid crystal display, the transmittance of light incident on the liquid crystal panel is controlled by the application of selected voltages to the field-generating electrodes so as to generate electric fields, the electric fields controlling the orientation of liquid crystal molecules in the liquid crystal layer, and thereby controlling the intensity of polarized light incident upon the liquid crystal panel.

A liquid crystal panel of the liquid crystal display does not emit light by itself, but the liquid crystal display can include a backlight unit as a light source to supply light to the liquid crystal panel to display an image.

In general, a backlight assembly includes a light source for irradiating light, a light guide plate (“LGP”) for guiding the light supplied from the light source to a liquid crystal panel, one or more optical sheets for improving the brightness and uniformity of the light emitted from the LGP to the liquid crystal panel, and a reflective sheet disposed below the LGP.

In a backlight assembly, in order to improve the brightness and uniformity of the light emitted to the liquid crystal panel, the optical sheets can include prisms, a top surface, and/or a bottom surface of a light guide plate.

However, the prisms can cause a moiré interference, deteriorating the display quality of a liquid crystal display. To address the problem of moiré interference, optical sheets can be separately used, however this increases the manufacturing cost.

### BRIEF SUMMARY OF THE INVENTION

Disclosed is a liquid crystal display capable of improving display quality while achieving a reduction in the manufacturing cost.

The above and other objects of this disclosure will be described in or be apparent from the following description.

The above described and other drawbacks are alleviated by a liquid crystal display including a liquid crystal panel having multiple pixels arranged at a first pitch; a light source for supplying a light to the liquid crystal panel; and a light guide plate for guiding the light to the liquid crystal panel, wherein the light guide plate includes a plurality of prisms disposed at a second pitch, wherein the second pitch is a sum of a quotient and a corrected value, wherein the quotient is determined by dividing the first pitch by a natural number m, and the corrected value is determined using a formula that includes a selected viewing distance and an interval between the liquid crystal panel and the prisms.

Also disclosed is a liquid crystal display including a liquid crystal panel having a plurality of pixels disposed at a first pitch; a light source for supplying light to the liquid crystal panel; a light guide plate for guiding the light to the liquid crystal panel; and an optical sheet interposed between the light guide plate and the liquid crystal panel, wherein at least one of the light guide plate and the optical sheet include a plurality of prisms having a second pitch, wherein the second pitch is a sum of a quotient and a corrected value, wherein the quotient is determined by dividing the first pitch by a natural number m, and the corrected value is determined using a selected viewing distance and an interval between the liquid crystal panel and the prisms.

Also disclosed is a method of manufacturing a liquid crystal display, the method including: disposing a liquid crystal panel having a plurality of pixels arranged at a first pitch; disposing a light source for supplying light to the liquid crystal panel; and disposing a light guide plate for guiding the light to the liquid crystal panel, wherein the light guide plate includes a plurality of prisms disposed at a second pitch, wherein the second pitch is determined as a sum of a quotient and a corrected value, wherein the quotient is determined by dividing the first pitch by a natural number (m), and wherein the corrected value is determined using a formula that includes a selected viewing distance and an interval between the liquid crystal panel and the prisms.

Also disclosed is a method of manufacturing a liquid crystal display, the method including: disposing a liquid crystal panel having a plurality of pixels disposed at a first pitch; disposing a light source for supplying light to the liquid crystal panel; disposing a light guide plate for guiding the light to the liquid crystal panel; and disposing an optical sheet interposed between the light guide plate and the liquid crystal panel, wherein at least one of the light guide plate and the optical sheet includes a plurality of prisms having a second pitch, wherein the second pitch is a sum of a quotient and a corrected value, wherein the quotient is determined by dividing the first pitch by a natural number (m), and wherein the corrected value is determined using a selected viewing distance and an interval between the liquid crystal panel and the prisms.

### BRIEF DESCRIPTION OF THE DRAWINGS

The disclosed subject matter is particularly pointed out and distinctly claimed in the claims at the conclusion of the specification. The foregoing and other objects, features and advantages of the disclosed embodiments are apparent from the following detailed description taken in conjunction with the accompanying drawings in which:

FIG. 1 is an exploded perspective view schematically illustrating a liquid crystal display according to an embodiment;

FIG. 2 is a plan view of the liquid crystal panel shown in FIG. 1;

FIG. 3 is a cross-sectional view illustrating a first embodiment of the liquid crystal panel and a light guide plate shown in FIG. 1;

FIG. 4 is a diagram that describes a pitch of prisms disposed on a bottom-surface shown in FIG. 3;

FIG. 5 is a graph of the moiré pitch as a function of the viewing distance for the embodiment shown in FIG. 3;

FIG. 6 is a cross-sectional view illustrating a second embodiment of the liquid crystal panel and the light guide plate shown in FIG. 1;

FIG. 7 is a diagram that describes a pitch of prisms disposed on a bottom-surface shown in FIG. 6;

FIG. 8 is a graph of the moiré pitch and the viewing distance for the embodiment shown in FIG. 6;

FIG. 9 is a diagram illustrating a relationship used to correct a pitch of prisms disposed on a bottom-surface in a liquid crystal display according to an embodiment;

FIG. 10 is a graph illustrating a relationship derived from the diagram shown in FIG. 9; and

FIG. 11 is a graph of moiré pitch and viewing angle as a function of the refractive index of a material disposed between a liquid crystal panel and a bottom-surface prism.

The detailed description explains the exemplary embodiments, together with aspects, advantages and features, by way of example with reference to the drawings.

### DETAILED DESCRIPTION OF THE INVENTION

Aspects, advantages and features and methods of this disclosure can be understood more readily by reference to the following detailed description of exemplary embodiments and the accompanying drawings. While this disclosure describes exemplary embodiments, it will be understood by those skilled in the art that various changes can be made and equivalents can be substituted for elements thereof without departing from the scope of this disclosure. The disclosed embodiments can have many different forms and should not be construed as being limited to the embodiments set forth herein. Rather, these embodiments are provided so that this disclosure will be thorough and complete and will fully convey the concept of the disclosure to those skilled in the art, and the disclosure will only be defined by the appended claims. Thus many modifications can be made to adapt a particular situation or material to the teachings of this disclosure without departing from the essential scope thereof. Therefore, it is intended that this disclosure not be limited to the particular embodiment disclosed as the best mode contemplated for carrying out this disclosure.

Like reference numerals refer to like elements throughout the specification. As used herein, the term “and/or” includes any and all combinations of one or more of the associated listed items.

It will be understood that, although the terms first, second, third, etc. can be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the embodiments are explained in more detail with reference to the accompanying drawings.

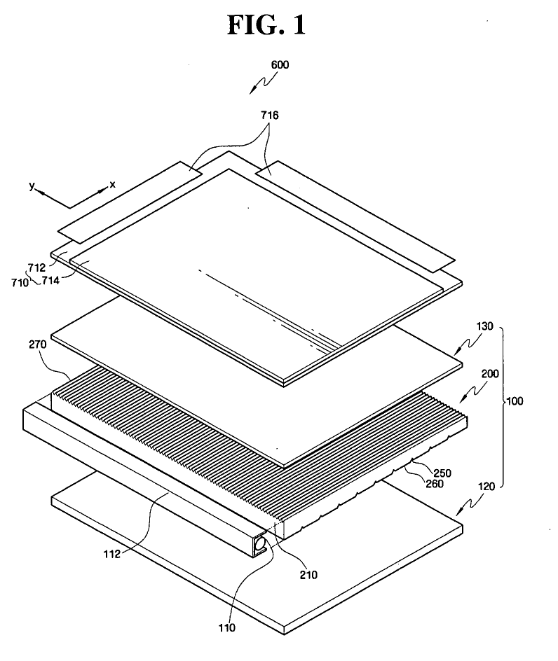

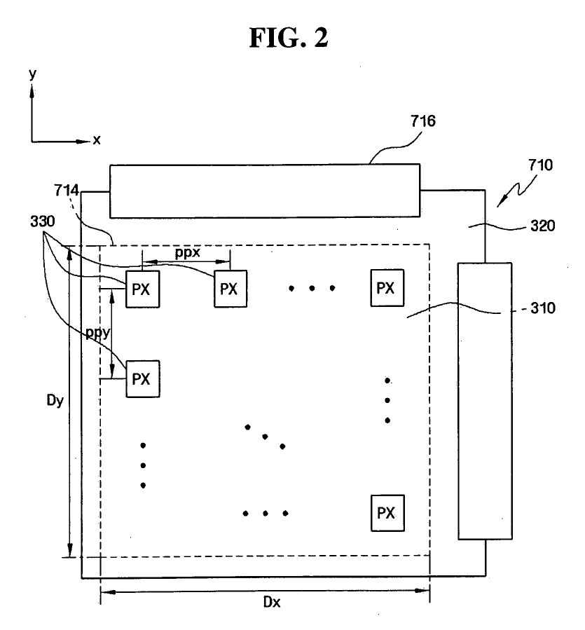

A liquid crystal display according to an embodiment will be described in detail with reference to FIGS. 1 and 2. FIG. 1 is an exploded perspective view schematically illustrating a liquid crystal display according to an embodiment, and FIG. 2 is a plan view of the liquid crystal panel shown in FIG. 1.

Referring to FIG. 1, the liquid crystal display 600 includes a liquid crystal panel 710 that displays an image, a driving circuit 716 that drives a liquid crystal panel 710, and a backlight assembly 100 that supplies light to the liquid crystal panel 710.

The liquid crystal panel 710 includes a first substrate 712, a second substrate 714 facing the first substrate 712, and a liquid crystal layer (not shown) interposed between the first substrate 712 and the second substrate 714.

The first substrate 712 can be a thin film transistor (“TFT”) substrate having TFTs (not shown), i.e., switching elements arranged in a matrix. A data line (not shown) and a gate line (not shown) are connected to the source and gate terminals and a pixel electrode is connected to the drain terminal in each TFT.

The second substrate 714 can be a color filter substrate having RGB pixels (not shown) disposed as a thin film for color display. A common electrode (not shown) made of a transparent conductive material can be formed on the second substrate 714.

In the liquid crystal panel 710 having the aforementioned configuration, when power is applied to the gate terminal of a TFT so that the TFT is turned on, an electric field is created between a pixel electrode and a common electrode. The orientation of liquid crystal molecules of the liquid crystal layer interposed between the first substrate 712 and the second substrate 714 is changed by the electric field created between the pixel electrode and the common electrode. The change in the orientation of liquid crystal molecules changes the transmission of the light supplied from the backlight assembly 100, thereby displaying an image of desired gray scales.

The driving circuit 716 includes a gate driver (not shown) generating a plurality of gate signals and supplying the same to the respective gate lines, and a data driver (not shown) generating image data voltages and supplying the same to the respective data lines.

The gate driver and the data driver are integrated circuits (“Ics”), which can be attached to the liquid crystal panel 710 in a tape carrier package (“TCP”) type, or a chip on film (“COF”) type. Alternatively, each of the gate driver and the data driver can be directly mounted on the liquid crystal panel 710 in the form of at least one integrated circuit (“IC”) chip.

Referring further to FIG. 2, the liquid crystal panel 300 can include a display area (DA) 310 on which an image is displayed, and a non-display area, i.e., a peripheral area (PA) 320 of the liquid crystal panel 300, on which an image is not displayed.

In the display area 310, a plurality of pixels (PX) 330 are arranged to display an image. The plurality of pixels 330 can be disposed repeatedly at a selected spacing. Here, the spacing between the pixels 330, i.e., a pitch between the pixels 330, can be divided into a pitch in the x-direction (ppx), and a pitch in the y-direction (ppy). Here, the x-direction is a direction that is parallel to a line normal to an incident surface 210 upon which light is incident from the light source 110, and the y-direction is a direction that is parallel to the incident surface 210 upon which light is incident from the light source 110. Meanwhile, the size of the display area 310 can be defined by the x-direction length (Dx) and the y-direction length (Dy).

In the peripheral area 320, an image is not displayed. As described above, the driving circuit 716 can be connected to the PA in the TCP or COF type integrated circuits. Alternatively, the driving circuit 716 can be directly mounted on the PA.

Referring back to FIG. 1, the backlight assembly 100 includes a light source 110 generating light, a light source cover 112 protecting the light source 110, a light guide plate 200 guiding the path of the light generated from the light source 110, a reflective sheet 120 disposed below the light guide plate 200, and an optical sheet 130 disposed above the light guide plate 200. The backlight assembly 100 can include a plurality of optical sheets 130.

The light source 110 can be disposed adjacent to the light guide plate 200. The light source 110 is responsive to external source of power and generates light. Exemplary light sources include a cold cathode fluorescent lamp (“CCFL”), an external electrode fluorescent lamp (“EEFL”) having external electrodes formed at opposite ends thereof, or the like, or a combination comprising at least one of the foregoing light sources. The shape of the light source is not limited. Exemplary shapes include a long cylindrical shape, a short cylindrical shape, a spherical shape, or the like, or a combination comprising at least one of the foregoing shapes.

The light source cover 112 covers three surfaces of the light source 110 and protects the light source 110. The light source cover 112 reflects the light generated from the light source 110 toward the light guide plate 200 while covering the light source 110, thereby improving the light utilization efficiency.

The light guide plate 200 guides the light incident from the light source 110. In order to prevent the loss of light, the guide plate 200 can comprise a transparent material. Exemplary materials for the light guide plate 200 include polyolefins such as polyethylene, polypropylene; polyamides such as Nylon 4,6, Nylon 6, Nylon 6,6, Nylon 6, 10, Nylon 6, 12; polyesters such as polyethelene terephthalate (“PET”), polybutylene terephthalate (“PBT”), poly(1 ,4-cyclohexane-dimethanol-1,4-cyclohexanedicarboxylate) (“PCCD”), poly(trimethylene terephthalate) (“PTT”), poly(cyclohexanedimethanol-co-ethylene terephthalate) (“PETG”), poly(ethylene naphthalate) (“PEN”), poly(butylene naphthalate) (“PBN”); polyimides, polyacetals, polyacrylics, polycarbonates (“PC”), polystyrenes, polyamideimides, polyarylates, polyacrylates, polyurethanes, polyarylsulfones, polyethersulfones, polysulfones, polyetherimides, polyarylene ethers, or the like, or combinations comprising at least one of the foregoing polymers, or copolymers of at least one of the foregoing polymers. In an embodiment, the polymer can have domains having a maximum dimension of less than 3000 Angstroms. In an exemplary embodiment, the material for the light guide plate is polymethyl methacrylate (“PMMA”).

The light guide plate 200 includes an incident surface 210 upon which the light is incident from the light source 110, a top surface 230 contacting the incident surface 210, and a bottom surface 220 contacting the incident surface 210 and facing the top surface.

As shown in FIG. 1, the light guide plate 200 can be wedge-shaped. That is, a thickness of the light guide plate 200, wherein the thickness is a distance from the bottom surface 220 to a top surface 230, is inversely related to a distance from the incident surface 210. Accordingly, although the light source 110 is disposed adjacent to the light guide plate 200, the light can reach all or a portion of the bottom surface 220 at a distance far from the light source 110. On the other hand, the light guide plate 200 can be configured to have a constant thickness between the top surface and a bottom surface. In this case, the light source 110 can be disposed at opposite sides of the light guide plate 200.

A top-surface prism 270 can be disposed on the top surface of the light guide plate 200, and a bottom-surface prism 250 and a flat portion 260 can be disposed on the bottom surface of the light guide plate 200.

The top-surface prism 270 can have a convex or concave portions. A plurality of top-surface prism 270 can be disposed throughout the entire surface of the top surface 230, the plurality can have a striped shape, and the top-surface prism can be disposed perpendicular to the incident surface 210.

The top-surface prism 270 can have a substantially triangular cross-sectional shape perpendicular to a longitudinal direction. Alternatively, an edge of the top-surface prism 270, disposed at the point where two inclined planes meet, can be bent. The top-surface prism 270 can also have a curved shape.

The bottom-surface prism 250 can have a concave shape. In order to make the light traveling inside the light guide plate 200 to be emitted in a vertical direction, the bottom-surface prism 250 can comprise a recess, the recess having a triangular cross-sectional shape.

A plurality of bottom-surface prisms 250 can be spaced apart from each other to form a striped shape disposed perpendicular to the incident surface 210.

The bottom-surface prism 250 can be parallel to the longitudinal direction of the light source 110. In contrast, since the top-surface prism 270 can be perpendicular to the incident surface 210, the top-surface prism 270 can be orthogonal to the bottom-surface prism 250.

A flat portion 260 can be disposed between each bottom-surface prism 250. When the light guide plate 200 has a wedge shape in which a thickness thereof gradually decreases with a distance from the incident surface 210, the spacing between the top surface 230 and the flat portion 260 can gradually decrease, or the spacing between the top surface 230 and the flat portion 260 can decrease in a step-wise fashion.

The flat portion 260 can be disposed perpendicular to the incident surface 210 so that the light guided inside the light guide plate 200 can satisfy the condition of total internal reflection, as shown in FIG. 1.

On the other hand, the flat portion 260 can be disposed so that it is inclined downwardly at a selected angle with respect to the top surface. The selected angle can be a function of the distance from the incident surface 210. In one exemplary embodiment, the flat portion 260 can be inclined at an angle, wherein the angle can be about 0.01 degrees to about 10 degrees, specifically about 0.1 degrees to about 1 degree, more specifically about 0.1 degrees to about 0.3 degrees.

If a flat portion 260 is inclined downwardly in such a manner, the incidence angle formed when the light incident on a flat portion 260 from the incident surface 210 is increased, thus a reflection angle is increased, thereby increasing a total internal reflection ratio. In addition, upon reflection, a distance from the center of the light reflected to a light reaching a point where the light is reflected next is extended, so that the number of times the light is reflected is reduced. Accordingly, a loss of light intensity can be minimized, thus increasing the effective intensity of the light emitted from the top surface of the light guide plate 200, thereby increasing the brightness.

With the structure of the aforementioned light guide plate 200, the light from the light source 110 is incident into the light guide plate 200 through the incident surface 210. The light can thus be totally reflected by the flat portion 260 wherein a reflection angle is changed by the bottom-surface prism 250. Accordingly, the light is emitted through the top surface of the light guide plate 200. In addition, collection of light in a horizontal direction can be achieved by the top-surface prism 270.

The reflective sheet 120 can be disposed below the light guide plate 200. The reflective sheet 120 reflects the light leaked from the light guide plate 200 and makes the reflected light incident toward the inside of the light guide plate 200. The reflective sheet 120 can be made of a highly reflective material. Exemplary materials for the reflective sheet 120 include white polyethylene terephthalate (PET), white polycarbonate (PC), titanium-dioxide-filled ABS (acrylonitrile-butadiene-styrene terpolymer), polymers which have been coated with a thin metallic layer such as silver, aluminum or gold, or the like, or a combination comprising at least one of the foregoing materials.

The optical sheet 130 can be disposed above the light guide plate 200 to improve the brightness of the light emitted from the light guide plate 200 or to enhance the appearance quality.

The optical sheet 130 can include a diffusion sheet (not shown). A diffusion sheet having a haze can address the problem associated with the appearance quality, such as bright lines, dark lines, dark portions at corners, or the like, which can be caused by the bottom-surface prism 250 and the top-surface prism 270 of the light guide plate 200. The haze of the diffusion sheet can be about 1% to about 99%, specifically about 20% to about 80%, more specifically about 50% to about 70%.

In addition, the optical sheet 130 can include a prism sheet (not shown). A plurality of prisms (not shown) connected to each other can be disposed on the prism sheet. The prism sheet can be stripe shaped and comprise a prism parallel to the top-surface prism 270 disposed on the top surface of the light guide plate 200.

Alternatively, the prism sheet can be stripe-shaped and comprise a prism perpendicular to the top-surface prism 270 disposed on the top surface of the light guide plate 200. Alternatively, the optical sheet 130 can include a prism sheet comprising a stripe in which a prism is disposed parallel to the top-surface prism 270, and another prism sheet comprising a stripe in which a prism is disposed perpendicular to the top-surface prism 270.

The prism can comprise a substantially triangular cross-sectional shape perpendicular to a longitudinal direction. The vertex of the prism can form an angle, wherein the angle can be about 70 degrees to about 179 degrees, specifically about 80 degrees to about 150 degrees, more specifically about 60 degrees to about 140 degrees. In addition, an edge of the prism disposed at the point where two inclined planes meet can be bent. The prism sheet can be curved, and the prism can be curved.

The optical sheet 130 can include a protective sheet (not shown). The protective sheet can be disposed above the prism sheet, the protective sheet can protect the prism sheet, and the protective sheet can prevent the prism sheet from contacting the liquid crystal panel 710 disposed above the prism sheet, thereby enhancing the appearance quality. The haze of the protective sheet can be about 20% to 99%, specifically 50% to 95%, more specifically about 70% to about 90%.

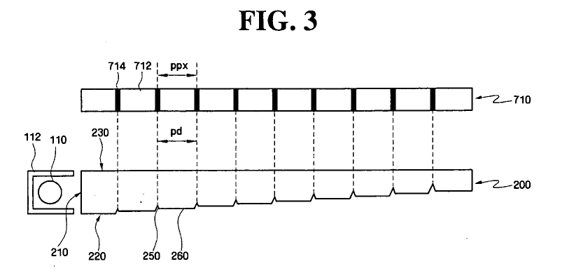

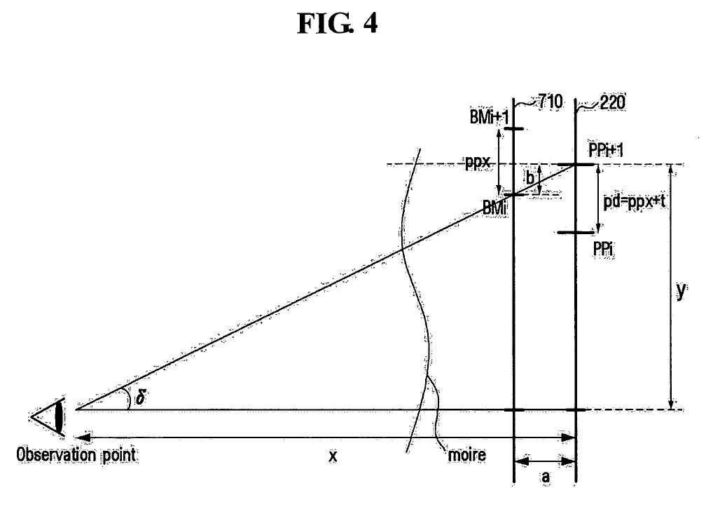

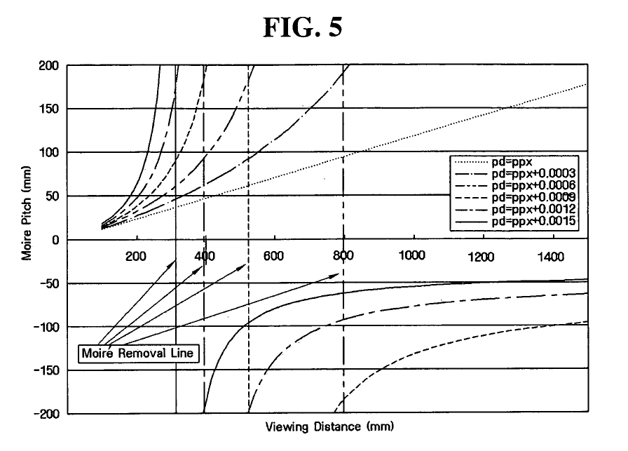

Hereinafter, the liquid crystal display according to a first embodiment will be described with reference to FIGS. 3 through 5. FIG. 3 is a cross-sectional view illustrating a first embodiment of the liquid crystal panel and a light guide plate shown in FIG. 1, and FIG. 4 is a diagram that describes a pitch between a plurality bottom-surface prisms shown in FIG. 3, and FIG. 5 is a graph of the moiré pitch as a function of the viewing distance for the embodiment shown in FIG. 3.

Referring to FIG. 3, the liquid crystal panel 710 can comprise and be divided by a plurality of panel openings 712 and black matrices 714. The panel opening 712 corresponds to an area of the liquid crystal panel 710 through which light is transmitted. A plurality of the black matrices 714 are disposed between pixels (see PX 330 of FIG. 2) to optically isolate the respective pixels and define the panel openings 712.

Since the black matrixes 714 are disposed at a constant spacing, a pitch between the pixels can be determined as the spacing between the black matrixes 714. In addition, the spacing between the black matrixes 714 can be determined parallel to a line from the light source 110 to the incident surface 210. Accordingly, the pitch between the pixels corresponds to an x-direction pitch (ppx).

A pitch (pd) between bottom-surface prisms 250 can be the same as the x-direction pitch (ppx). Specifically, the pitch (pd) between bottom-surface prisms 250 can be the sum of the x-direction pitch (ppx) and a corrected value (t), which will be described below.

A moiré phenomenon observed in a liquid crystal display can be described using the diagram in FIG. 4. In FIG. 4, the eye of a viewer of a liquid crystal display is defined as an observation point. A distance from the observation point to a bottom surface 220 having the bottom-surface prism 250 is defined as a viewing distance (x). A perpendicular line drawn from the observation point to the liquid crystal panel 710 is defined as a reference line.

In FIG. 4, (b) denotes a vertical distance measured in a direction perpendicular to the reference line between an i^{th} black matrix (BMᵢ) and an (i+1)^{th} bottom-surface prism PP₍ᵢ₊₁₎. The interval between the liquid crystal panel 710 and the bottom surface 220 having the bottom-surface prism 250 is denoted by (a). If the light guide plate 200 has a constant spacing between the top surface 230 and the bottom surface 220, the interval (a) has a constant value. On the other hand, as shown in FIG. 3, if the light guide plate 200 has a wedge shape, that is to say, if the spacing between the top surface 230 and the bottom surface 220 is less at distances farther from the incident surface 210, the interval (a) corresponds to an average interval between the liquid crystal panel 710 and the bottom surface 220.

Referring again to FIG. 4, the spacing between the i^{th} black matrix BMᵢ, and an (i+1)^{th} black matrix BM₍ᵢ₊₁₎, corresponds to the x-direction pitch (ppx). In addition, the spacing between the i^{th} bottom-surface prism PPᵢ and the (i+1)^{th} bottom-surface prism PP₍ᵢ₊₁₎, that is, the pitch (pd) between bottom-surface prisms 250, is the sum of the x-direction pitch (ppx) and a corrected value, which will be described below.

The moiré phenomenon is generated by light interference occurring because of the arrangement of a plurality of the bottom-surface prisms 250 of the light guide plate 200 and the pixel arrangement.

Referring to FIG. 4, the observation point, the i^{th} black matrix BMᵢ, (where (i) is a natural number), and the (i+1)^{th} bottom-surface prism PP₍ᵢ₊₁₎, are positioned on the same line at an observation angle (δ). Here, the observation angle (δ) is an internal angle defined by a straight line connecting the observation point, the i^{th} black matrix BMᵢ, and the (i+1)^{th} bottom-surface prism PP₍ᵢ₊₁₎ and the reference line, when the viewer views the i^{th} black matrix BMᵢ and the (i+1)^{th} bottom-surface prism PP₍ᵢ₊₁₎ from the observation point.

Under these circumstances, if (b) is equal to the x-direction pitch (ppx), a moiré pattern is observed by a viewer at a distance from the reference line to the (i+1)^{th} bottom-surface prism PP₍ᵢ₊₁₎. That is to say, the pitch (y) of the moiré corresponds to a distance from the reference line to the (i+1)^{th} bottom-surface prism PP₍ᵢ₊₁₎. Based on this observation, the moiré pitch (y) can be represented by Equation 1:

[Note: italics were used in some of the original formulas and not in the FIGS. For consistency this draft uses standard pitch throughout]

y=ppx*i+b=(ppx+t)*(i+1) (1)

The vertical distance (b) can be derived from Equation 1, as represented by Equation 2:

b=ppx+t*(i+1) (2)

Meanwhile, Equation 3 can be obtained geometrically, as shown in FIG. 4:

x−a:ppx*i=a:b (3)

That is, ppx*i*a=(x−a)*b

Equation 4 can be obtained by solving the simultaneous equations 2 and 3 for (i):

$$i = \frac{( ppx + t ) * ( x - a )}{( ppx * a - t * ( x - a ) )} \qquad ( 4 )$$

Equation 5 can be obtained by applying Equation 4 to Equation 1:

$$y = ( ppx + t ) * [ \frac{( ppx + t ) * ( x - a )}{( ppx * a - t * ( x - a ) )} + 1 ] \qquad ( 5 )$$

In Equation 5, the x-directional pitch (ppx) and the interval (a) between the liquid crystal panel 710 and the bottom surface 220 having the bottom-surface prism 250 are selected values. Accordingly, Equation 5 can be an expression of the moiré pitch (y) as a function of the corrected value (t) and the viewing distance (x).

In the course of expressing the moiré pitch (y) as a function of the corrected value (t) and the viewing distance (x), as an example, consider a case where the observation angle (δ) is large. In the foregoing description, an assumption is made that the observation point, the i^{th} black matrix BMᵢ, (where (i) is a natural number), and the (i+1)^{th} bottom-surface prism PP₍ᵢ₊₁₎, are positioned on the same line at an observation angle (δ). If the observation angle (δ) increases, the observation point, the i^{th} black matrix BMᵢ, and an (i+k)^{th} bottom-surface prism PP₍ᵢ₊ₖ₎ can be positioned on the same line (where k is a natural number equal to or greater than 2) at the observation angle (δ).

Under these circumstances, k moiré patterns can be observed by the viewer at a distance from the reference line to the (i+k)^{th} bottom-surface prism PP₍ᵢ₊ₖ₎. In this case, assuming that y₍ₖ₎ is a vertical distance in which a k moiré pattern is observed from the reference line, y₍ₖ₎ can be represented in the following Equation 6:

y₍ₖ₎=ppx*i+b=(ppx+t)*(i+k) (6)

The vertical distance, labeled b, can be derived from Equation 6, as shown by Equation 7:

b=ppx*k+t*(i+k) (7)

Equation 8 can be obtained by solving the simultaneous equations 7 and 3 for (i):

$$i = \frac{k * ( ppx + t ) * ( x - a )}{( ppx * a - t * ( x - a ) )} \qquad ( 8 )$$

Equation 9 can be obtained by applying Equation 8 to Equation 6:

$${y}_{( k )} = ( ppx + t ) * [ \frac{k * ( ppx + t ) * ( x - a )}{( ppx * a - t * ( x - a ) )} + k ] \qquad ( 9 )$$

Accordingly, the distance y₍ₖ₋₁₎ in which the (k−1)^{th} moiré pattern occurs can be expressed from the reference line, as represented in the following Equation 10:

$${y}_{( k - 1 )} = ( ppx + t ) * [ \frac{( k - 1 ) * ( ppx + t ) * ( x - a )}{( ppx * a - t * ( x - a ) )} + ( k - 1 ) ] \qquad ( 10 )$$

Thus, the moiré pitch (y) can be obtained by a difference between y₍ₖ₎ and y₍ₖ₋₁₎, as represented in the following Equation 11:

$$\begin{matrix}y = {y}_{( k )} - {y}_{( k - 1 )} \\ = ( ppx + t ) * [ \frac{( ppx + t ) * ( x - a )}{( ppx * a - t * ( x - a ) )} + 1 ) ]\end{matrix} \qquad ( 11 )$$

Thus, Equation 11 equivalent to Equation 5, therefore even if the observation angle (δ) increases, the moiré pitch (y) can be derived from the same equation.

Hereinafter, a method of calculating the pitch (pd) between individual bottom-surface prisms 250 using Equation 11 will be described by referring further to FIG. 5. Specifically, a method of determining a corrected value (t) to be added to the x-directional pitch (ppx) will now be described.

FIG. 5 is a graph showing the moiré pitch (y) as a function of the viewing distance (x) for various values of the corrected value (t) added to the x-direction pitch (ppx) in Equation 11. By way of example, the graph shown in FIG. 5 is applied to a personal computer. In FIG. 5, it is assumed that the interval (a) is 1.35 μm and the x-directional pitch (ppx) is 237 μm.

Referring to FIG. 5, in a case where no correction is made, the pitch (pd) between bottom-surface prisms 250 is equal to the x-direction pitch (ppx), and the moiré pitch (y) is observed to linearly increase with respect to the viewing distance (x). In other words, the greater the viewing distance (x) from the viewer, the greater moiré pitch (y) observed by the viewer.

If the corrected value (t) is added to the x-direction pitch (ppx), the moiré pitch (y) has a hyperbolic trajectory. In one exemplary embodiment, when t=0.0012 mm, a hyperbolic curve having an asymptote of about x=400 mm is observed.

The asymptote can also be referred to as a moiré removal line. At a viewing distance (x) substantially the same as the asymptote, the moiré pitch (y) increases, approaching infinity, thus the moiré is not observed by the viewer.

Accordingly, the moiré pitch (y) as a function of the viewing distance (x) can be illustrated for a selected corrected value (t), thereby finding a viewing distance (x) at which the moiré pitch (y) approaches infinity. Illustrated in FIG. 5 is the observation that as the corrected value (t) is increased, the viewing distance x of the asymptote approaches zero. Thus, as the corrected value (t) is increased, the viewing distance (x) corresponding to the moiré removal line is reduced.

The corrected value (t) for the moiré pitch (y) can be selected such that the moiré cannot be substantially observed by a viewer.

Shown in FIG. 2 is a liquid crystal panel having a display area (DA) 310 with dimensions Dx by Dy. The corrected value (t) can be selected such that the moiré pitch (y) is greater than half a dimension (Dx or Dy) of a display area (DA) of the liquid crystal display on which an image is displayed. Thus, if the moiré pitch (y) is greater than half of Dx or Dy, it has been observed that the viewer is substantially unable to observe a moiré phenomenon occurring on the liquid crystal display.

In one exemplary embodiment, if a dimension of a display area DA in which an image is displayed on a personal computer is such that Dx or Dy is 200 mm, the corrected value (t) can be selected such that the moiré pitch (y) is not less than half of 200 mm, i.e., 100 mm.

Thus, in an example, if the viewing distance (x) of a personal computer is 450 mm on average, the corrected value (t) can be selected to be 0.0009 mm so that an asymptote of the moiré pitch (y) is greater than or equal to 100 mm in FIG. 5, for example. Accordingly, the corrected value (t) can be selected to be about 1 μm.

According to a first embodiment, the display quality of the liquid crystal display can be improved and a reduction in the manufacturing cost thereof can be achieved.

In detail, increasing the haze of a liquid crystal panel itself or using an optical sheet having a haze value can reduce the moiré observed by the viewer. However, although increasing the haze can compensate for the moiré visibility, the brightness can be undesirably reduced, ultimately deteriorating the display quality of the liquid crystal display.

However, in the liquid crystal display having the prism spacing according to the first embodiment, the visibility of the moiré can be reduced without increasing the haze. Thus the structure of the liquid crystal display having the aforementioned prisms improves the display quality without sacrificing the brightness of the liquid crystal display. Furthermore, additional treatments to increase a haze value of a liquid crystal panel, or use of a separate optical sheet having a high haze value, either of which can be performed for the purpose of reducing the moiré observability, can be obviated, thereby reducing the manufacturing cost of the liquid crystal display.

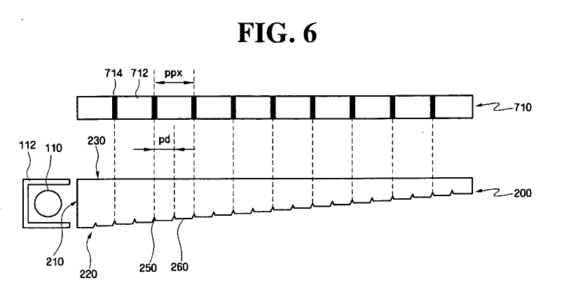

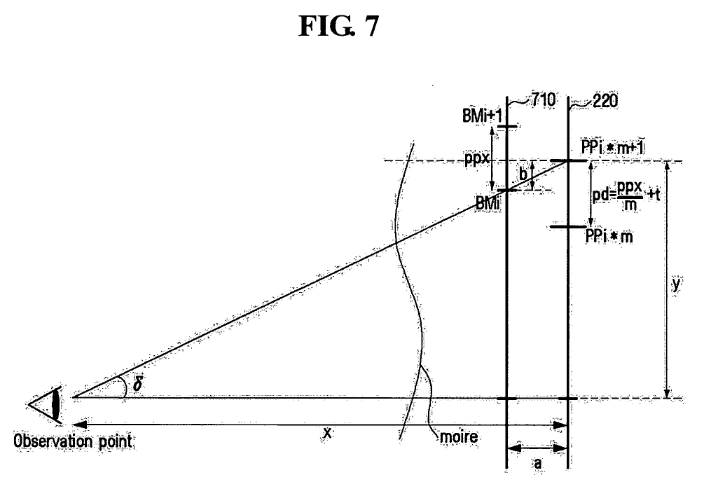

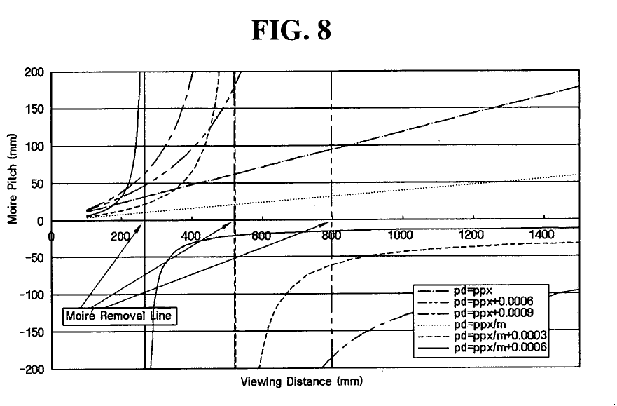

Hereinafter, a liquid crystal display according to a second embodiment will be described with reference to FIGS. 6 through 8. FIG. 6 is a cross-sectional view illustrating a second embodiment of the liquid crystal panel and the light guide plate shown in FIG. 1, and FIG. 7 is a is diagram that describes a pitch of a plurality of bottom-surface prisms shown in FIG. 6, and FIG. 8 is a graph of the moiré pitch as a function of the viewing distance for the embodiment shown in FIG. 6. Components which have essentially the same function as those of the liquid crystal display according to the first embodiment are denoted by the same reference numerals as the corresponding components, thus a description thereof are omitted.

Referring to FIG. 6, a pitch (pd) between the a plurality of bottom-surface prisms 250 is roughly the same as a quotient obtained by dividing the x-direction pitch (ppx) by (m), where m is a natural number m. Specifically, the pitch (pd) between the bottom-surface prisms 250 is the sum of a quotient obtained by dividing the x-direction pitch (ppx) by a natural number, i.e., m, and a corrected value (t), to be later described. While FIG. 6 shows an example of a case where m=2, in the following description, m is not limited to 2 and any other natural number can be applied to m. Thus m can be about 1 to about 100, specifically about 10 to about 90, or more specifically about 25 to about 75.

In FIG. 7, (b) denotes a vertical distance measured in a direction perpendicular to the reference line between an i^{th} black matrix BMᵢ and an (i*m+1)^{th} bottom-surface prism pattern PP_{(i*m+1)}. In addition, a spacing between an (i*m)^{th} bottom-surface prism PP_{(i*m)}, and an (i*m+1)^{th} bottom-surface prism PP_{(i*m+1)}, that is, a pitch (pd) between the bottom-surface prisms 250, is the sum of a quotient obtained by dividing the x-direction pitch (ppx) by m and a corrected value (t) to be described later.

Referring to FIG. 7, the observation point, the i^{th} black matrix BMᵢ, (where (i) is a natural number), and the (i*m+1)^{th} bottom-surface prism PP_{(i*m+1)}, are positioned on the same line at an observation angle (δ). Here, the observation angle (δ) is an internal angle formed by the straight line connecting the observation point, the i^{th} black matrix BMᵢ, and the (i*m+1)^{th} bottom-surface prism PP_{(i*m+1)}, and the reference line, when the viewer views i^{th} black matrix BMᵢ, and the (i*m+1)^{th} bottom-surface prism PP_{(i*m+1)} from the observation point.

Under these circumstances, if (b) is equal to the x-direction pitch (ppx), a moiré pattern is observed by the viewer at a distance from the reference line to the (i*m+1)^{th} bottom-surface prism PP_{(i*m+1)}. Thus, the pitch (y) of the moiré observed corresponds to the distance from the reference line to the (i*m+1)^{th} bottom-surface prism pattern PP_{(i*m+1)}. Based on this observation, the moiré pitch (y) can be represented by Equation 12:

y=ppx*i+b=(ppx/m+t)*(i*m+1) (12)

The vertical distance (b) can be derived from Equation 12, as represented by Equation 13:

b=ppx/m+(i*m+1)*t (13)

Meanwhile, Equation 14 can be obtained geometrically, as shown in FIG. 7:

x−a:ppx*i=a:b (14)

That is, ppx*i*a=(x−a)*b.

Equation 15 can be obtained by solving the simultaneous equations 13 and 14 for (i):

$$i = \frac{( ppx / n + t ) * ( x - a )}{( ppx * a - t * m * ( x - a ) )} \qquad ( 15 )$$

Equation 16 can be obtained by applying Equation 15 to Equation 12:

$$y = ( \frac{ppx}{m} + t ) * [ \frac{m * ( ppx / m + t ) * ( x - a )}{( ppx * a - t * m * ( x - a ) )} + 1 ] \qquad ( 16 )$$

In Equation 16, the x-direction pitch (ppx), the interval (a) between the liquid crystal panel 710 and the bottom surface 220 having the bottom-surface prism 250, and the natural number m are selected values. Accordingly, Equation 16 can be an expression of the moiré pitch (y) as a function of the corrected value (t) and the viewing distance (x).

By expressing the moiré pitch (y) as a function of the corrected value (t) and the viewing distance (x), even if the observation angle (δ) increases, the moiré pitch (y) can be derived from the same equation. The derivation procedure is substantially the same as in the first embodiment, thus a description thereof will not be given.

Hereinafter, referring further to FIG. 8, a method of obtaining a pitch (pd) between a plurality of bottom-surface prisms 250 using Equation 16 will be described. That is, a method of determining a corrected value (t) to be added to the quotient obtained by dividing the x-direction pitch (ppx) by (m) will now be described.

FIG. 8 is a graph showing the moiré pitch (y) as a function of the viewing distance (x) at increasing values of the corrected value (t) added to the quotient obtained by dividing the x-direction pitch (ppx) by (m) in Equation 16. The graph shown in FIG. 8 is applied to a personal computer by way of example. In FIG. 5, it is assumed that the interval (a) is 1.35 μm and the x-directional pitch (ppx) is 237 μm. For comparison, some asymptotes from the first embodiment are also shown in FIG. 8.

Referring to FIG. 8, in a case where no correction is made, that is, the pitch (pd) between the bottom-surface prisms 250 is equal to the quotient obtained by dividing the x-direction pitch (ppx) by (m), the moiré pitch (y) linearly increases with the viewing distance (x). For the same viewing distance (x), a smaller moiré pitch (y) is observed by the viewer than in the first embodiment, which means that the moiré phenomenon is more clearly observed by the viewer than in the first embodiment.

If the corrected value (t) is added to the quotient obtained by dividing the x-direction pitch (ppx) by (m), the moiré pitch (y) is observed to have a hyperbolic trajectory. When compared with the corrected value (t) in the first embodiment, a moiré removal line is observed to be at a shorter viewing distance (x). In addition, the moiré pitch (y) changes more sharply before and after the moiré removal line.

The corrected value (t) can be determined in the same manner as in the first embodiment. However, when compared with the first embodiment, since the moiré pitch (y) changes more sharply before and after the moiré removal line, the range of viewing distances (x) wherein the pitch (y) will make the moiré substantially unobservable by the viewer is smaller. Thus, more accurate correction is desired than in the first embodiment.

According to the second embodiment, like in the first the embodiment, display quality of the liquid crystal display can be improved and a reduction in the manufacturing cost thereof can be achieved.

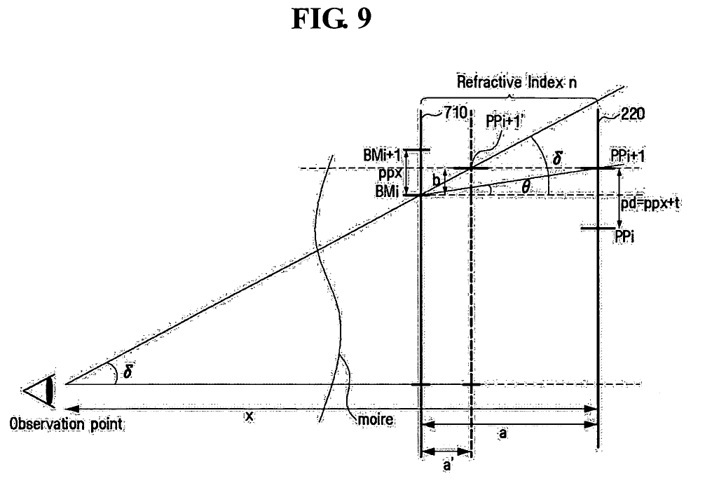

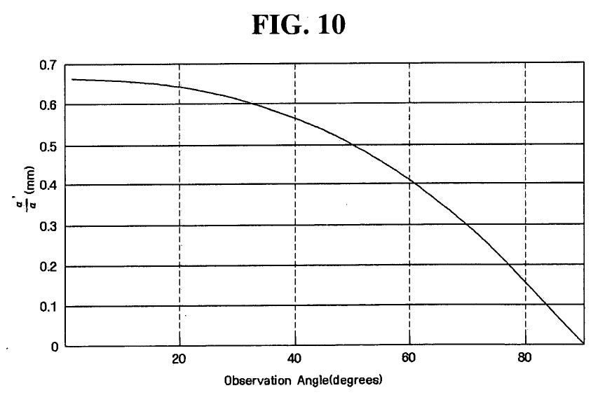

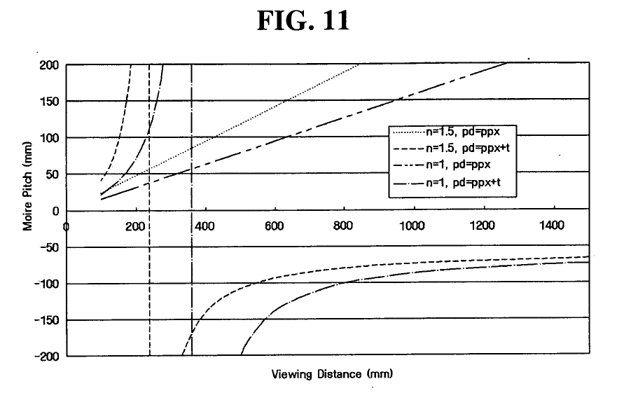

Hereinafter, a liquid crystal display according to a third embodiment will be described with reference to FIGS. 9 through 11. FIG. 9 is a diagram that describes a pitch of a plurality of bottom-surface prisms in a liquid crystal display according to a third embodiment, FIG. 10 is a graph that shows a relationship derived from FIG. 9, and FIG. 11 is a graph of the moiré pitch as a function of the viewing distance and the refractive index of a material interposed between a liquid crystal panel and a plurality of bottom-surface prisms. In FIG. 11, it is assumed that the interval (a) is 2 μm, the x-direction pitch (ppx) is 237 μm, and the corrected value (t) is 1 μm.

A correction made on a value of the interval (a) between a liquid crystal panel 710 and a bottom surface 220 (which includes a bottom-surface prism 250), as disclosed in the third embodiment, can be applied to both the first and second embodiments. The correction considers the refractive index of a material between a liquid crystal panel 710 and a bottom surface 220 (which includes a bottom-surface prism 250). In this regard, an explanation will be given only for the case of the first embodiment, for brevity. Components that have essentially the same function as those of the liquid crystal display according to the first embodiment are denoted by the same reference numerals as the corresponding components and description thereof will be omitted.

Referring to FIG. 9, unlike in the first embodiment, in the third embodiment, a material having a refractive index (n) is interposed between the liquid crystal panel 710 and the bottom surface 220 (which comprises a bottom-surface prism). While a refractive index has not been taken into consideration in the first embodiment, in this exemplary embodiment, it is assumed that an internal air space having a refractive index of 1 is between the liquid crystal panel 710 and the bottom surface 220 (which includes a bottom-surface prism).

A method of obtaining the relationship used to correct a value of the interval (a) between the liquid crystal panel 710 and the bottom surface 220 (which includes a bottom-surface prism) in the liquid crystal display according to the third embodiment will now be described.

Referring to FIG. 9, the observation point, the i^{th} black matrix BMᵢ, and a virtual point PP_{(i+1′)} are selected such that they are positioned on the same line at the observation angle (δ).

According to Snell's law, light is bent at an interface of two different materials having different refractive indexes towards the material having a greater refractive index of two materials. As a result, the light incident from the (i+1)^{th} bottom-surface prism pattern PP₍ᵢ₊₁₎ is perceived by the viewer as if it was incident from the virtual point PP_{(i+1′)}.

Accordingly, the value of the interval (a) between the liquid crystal panel 710 and the bottom surface 220 (comprising a bottom-surface prism 250) should be a distance a′ which is a distance from the liquid crystal panel 710 to a virtual point PP_{(i+1′)}. The equation for converting the interval (a) of Equation 5 in the first embodiment into a′ can be rewritten as Equation 17:

$$y = ( \frac{ppx}{m} + t ) * [ \frac{m * ( ppx / m + t ) * ( x - {a}^{′} )}{( ppx * {a}^{′} - t * m * ( x - {a}^{′} ) )} + 1 ) ] \qquad ( 17 )$$

Equation 18 is derived using Snell's Law:

Sin(δ)=n*Sin θ (18)

Meanwhile, Equation 19 can be obtained geometrically, as shown in FIG. 9:

a:a′=tan(90−δ):tan(90−θ) (19)

That is, a=a′*[ cos δ/sin(δ)]/[ cos θ/sin θ]

Equation 20 can be obtained by solving the simultaneous equations 18 and 19:

a=a′*cos δ/(n*cos θ) (20)

Equation 21 can be obtained by solving the simultaneous equations 18 and 20:

a′=a*cos δ/[n*\sqrt{1−(sin δ/n)²}] (21)

FIG. 10 is a graph representing a ratio of a′/a as a function of observation angle (δ) when the refractive index n is 1.5 in Equation 21.

The pitch (pd) between the bottom-surface prisms 250 can be obtained using Equation 17 and Equation 21 in the same manner as in the first embodiment. Thus, the corrected value (t) to be added to the x-direction pitch (ppx) can be determined.

Next, assuming that the spacing (pd) between the bottom-surface prisms is constant, comparison between the moiré pitch (y) in a case of a material having a refractive index of 1 and the moiré pitch (y) in case of a material having a refractive index of 1.5 will be made with reference to FIG. 11.

Referring to FIG. 11, for the same viewing distance (x), the greater the refractive index, the greater the moiré pitch (y) observed by the viewer, which means that the moiré phenomenon is less observable by a viewer when the refractive index is increased. In addition, the greater the refractive index, the shorter the viewing distance (x) at which the moiré removal line appears.

According to the third embodiment, like in the first the embodiment, display quality of the liquid crystal display can be improved and a reduction in the manufacturing cost thereof can be achieved.

While the distribution of prisms disposed on the bottom surface of a light guide plate have been described in the first through third embodiments, the prisms can also be disposed on a top surface of a light guide plate or on an optical sheet. Thus, the disclosed method can be applied to any type of prism arrangement that is included in a backlight assembly, including a prism disposed on a prism sheet, as well as the bottom-surface prism in a light guide plate.

In general, the pitch of prisms can be determined using the following equations:

$$\begin{matrix}y = ( p + t ) * [ \frac{m * ( p + t ) * ( x - a )}{( p * a - t * ( x - a ) )} + 1 ) ] & ( 22 ) \\ y = ( \frac{p}{m} + t ) * [ \frac{m * ( p / m + t ) * ( x - a )}{( p * a - t * m * ( x - a ) )} + 1 ) ] & ( 23 ) \\ y = ( \frac{p}{m} + t ) * [ \frac{m * ( p / m + t ) * ( x - {a}^{′} )}{( p * {a}^{′} - t * m * ( x - {a}^{′} ) )} + 1 ] & ( 24 ) \\ {a}^{′} = a * cos δ / [ n * \sqrt{1 - {( sin δ / n )}^{2}} ] & ( 25 )\end{matrix}$$

In Equation 22 through Equation 25, (p) is a pixel pitch. Assuming that prisms are disposed parallel to a line normal to an incident surface 210 (of light provided from the light source 110), (p) corresponds to the x-direction pitch (ppx). If prisms are disposed parallel to an incident surface 210 (of light provided from the light source 110), (p) becomes the y-direction pitch (ppy).

While embodiments have been particularly shown and described with reference to exemplary embodiments thereof, it will be understood by those of ordinary skill in the art that various changes in form and details can be made therein without departing from the spirit and scope of the disclosed embodiments as defined by the following claims. It is therefore desired that the embodiments be considered in all respects as illustrative and not restrictive, reference being made to the appended claims rather than the foregoing description to indicate the scope of the disclosure.

What is claimed is:

1. A liquid crystal display comprising:
a liquid crystal panel having a plurality of pixels arranged at a first pitch;
a light source which supplies a light to the liquid crystal panel; and
a light guide plate which guides the light to the liquid crystal panel, wherein the light guide plate comprises a plurality of prisms disposed at a second pitch, wherein the second pitch is a sum of a quotient and a corrected value, wherein the quotient is determined by dividing the first pitch by a natural number (m), and the corrected value is determined using a formula that comprises a selected viewing distance and an interval between the liquid crystal panel and the prisms.

2. The liquid crystal display of claim 1, wherein the corrected value (t) is determined by the formula:
$$y = ( \frac{p}{m} + t ) * [ \frac{m * ( p / m + t ) * ( x - a )}{( p * a - t * m * ( x - a ) )} + 1 ) ] ,$$
wherein (p) is the first pitch, and (a) is the interval between the liquid crystal panel and the prisms, and wherein the corrected value is such that a moiré pitch (y) is greater than a selected value at a preset viewing distance (x).

3. The liquid crystal display of claim 2, wherein the corrected value is determined using a graph of the moiré pitch (y) and the viewing distance (x), wherein the corrected value is selected such that the moiré pitch (y) approaches infinity.

4. The liquid crystal display of claim 2, wherein the corrected value is determined using a graph of the moiré pitch (y) and the viewing distance (x), wherein the corrected value is selected such that the moiré pitch (y) is greater than half of a dimension of a display area of the liquid crystal display.

5. The liquid crystal display of claim 1, wherein (n) is an average refractive index of a material between the liquid crystal panel and a prism, and the corrected value is determined by the formulas:
$$y = ( \frac{p}{m} + t ) * [ \frac{m * ( p / m + t ) * ( x - {a}^{′} )}{( p * {a}^{′} - t * m * ( x - {a}^{′} ) )} + 1 ) ] , \\ and$$
$${a}^{′} = a * cos δ / [ n * \sqrt{1 - {( sin δ / n )}^{2}} ] ,$$
and the corrected value is selected such that a moiré pitch (y) is greater than a selected value at the preset viewing distance (x), wherein (p) is the first pitch, (t) is the corrected value, and (a) is the interval between the liquid crystal panel and the prism.

6. The liquid crystal display of claim 5, wherein the corrected value is determined using a graph of the moiré pitch (y) and the viewing distance (x), wherein the corrected value is selected such that the moiré pitch (y) approaches infinity.

7. The liquid crystal display of claim 5, wherein the corrected value is determined using a graph of the moiré pitch (y) and the viewing distance (x), wherein the corrected value is selected such that the moiré pitch (y) is greater than half of a dimension of a display area of the liquid crystal display.

8. The liquid crystal display of claim 1, wherein the light guide plate includes an incident surface upon which a light from the light source is incident, a top surface contacting the incident surface, and a bottom surface contacting the incident surface and facing the top surface, wherein the bottom surface comprises a prism.

9. The liquid crystal display of claim 8, further comprising a flat portion between a plurality of the prisms, wherein a first distance between a first flat portion and the top surface is greater than a second distance between a second flat portion and the top surface, and wherein the first flat portion is nearer to the incident surface than the second flat portion.

10. The liquid crystal display of claim 8, wherein a distance between the top surface and the bottom surface is inversely related to a distance from the incident surface, and an interval between the liquid crystal panel and a prism is equal to at least one of an average interval between the liquid crystal panel and the top surface and an average interval between the liquid crystal panel and the bottom surface.

11. The liquid crystal display of claim 1, wherein a prism is disposed parallel to an incident surface and wherein the first pitch is determined in a direction normal to the incident surface.

12. The liquid crystal display of claim 1, wherein a prism is disposed parallel to a line normal to an incident surface and wherein the first pitch is determined in a direction parallel to the incident surface.

13. A liquid crystal display comprising:
a liquid crystal panel having a plurality of pixels disposed at a first pitch;
a light source for supplying light to the liquid crystal panel;
a light guide plate for guiding the light to the liquid crystal panel; and
an optical sheet interposed between the light guide plate and the liquid crystal panel,
wherein at least one of the light guide plate and the optical sheet comprise a plurality of prisms having a second pitch, wherein the second pitch is a sum of a quotient and a corrected value, wherein the quotient is determined by dividing the first pitch by a natural number (m), and the corrected value is determined using a selected viewing distance and an interval between the liquid crystal panel and the prisms.

14. The liquid crystal display of claim 13, wherein the corrected value is determined by the formula:
$$y = ( \frac{p}{m} + t ) * [ \frac{m * ( p / m + t ) * ( x - a )}{( p * a - t * m * ( x - a ) )} + 1 ) ] ,$$
wherein (p) is the first pitch, (t) is the corrected value, and (a) is an interval between the liquid crystal panel and a prism, and wherein the corrected value is such that a moiré pitch (y) is greater than a selected value at a selected viewing distance (x).

15. The liquid crystal display of claim 14, wherein the corrected value is determined using a graph of the moiré pitch (y) and the viewing distance (x), wherein the corrected value is selected such that the moiré pitch (y) is greater than half of a dimension of a display area of the liquid crystal display.

16. The liquid crystal display of claim 13, wherein (n) is an average refractive index of a material between the liquid crystal panel and a prism, and the corrected value is determined by the formulas:
$$y = ( \frac{p}{m} + t ) * [ \frac{m * ( p / m + t ) * ( x - {a}^{′} )}{( p * {a}^{′} - t * m * ( x - {a}^{′} ) )} + 1 ) ] , \\ and$$
$${a}^{′} = a * cos δ / [ n * \sqrt{1 - {( sin δ / n )}^{2}} ] ,$$
and the corrected value is selected such that a moiré pitch (y) is greater than a selected value at a selected viewing distance (x), wherein (p) is the first pitch, (t) is the corrected value, and (a) is the interval between the liquid crystal panel and a prism.

17. The liquid crystal display of claim 16, wherein the corrected value is determined using a graph of the moiré pitch (y) and the viewing distance (x), wherein the corrected value is selected such the moiré pitch (y) is greater than half of a dimension of a display area of the liquid crystal display.

18. The liquid crystal display of claim 13, wherein the prisms are disposed parallel to the incident surface, and wherein the first pitch is determined in a direction normal to the incident surface.

19. The liquid crystal display of claim 13, wherein the prisms are disposed parallel to a line normal to the incident surface, and wherein the first pitch is determined in a direction parallel to the incident surface.
